(19) United States
(12) Patent Application Publication
(10) Pub. No.: US 2026/0094943 A1
(43) Pub. Date: Apr. 2, 2026

(54) POWER STORAGE MODULE AND POWER STORAGE DEVICE

(71) Applicant: KABUSHIKI KAISHA TOYOTA JIDOSHOKKI, Kariya-shi, Aichi (JP)

(72) Inventors: Yuki OKAMOTO, Kariya-shi, Aichi (JP); Fumihiko ISHIGURO, Kariya-shi, Aichi (JP); Takayuki HIROSE, Kariya-shi, Aichi (JP)

(73) Assignee: KABUSHIKI KAISHA TOYOTA JIDOSHOKKI, Kariya-shi, Aichi (JP)

(21) Appl. No.: 19/110,615

(22) PCT Filed: Aug. 22, 2023
(86) PCT No.: PCT/JP2023/030185

§ 371 Date: Mar. 11, 2025

(30) Foreign Application Priority Data
Sep. 20, 2022 (JP) 2022-149347

(51) Int. Cl. H01M 50/463; H01M 4/02; H01M 4/70; H01M 50/46

(52) U.S. Cl. CPC H01M 50/463; H01M 4/70; H01M 50/46; H01M 2004/029

(57) ABSTRACT

A power storage module includes a main body portion provided with communication paths, and a liquid injection portion that is attached to one side surface of the main body portion and includes injection ports each communicating with the communication paths. Liquid injection frames provided in the main body portion include a first liquid injection frame in which a part of the liquid injection frame protrudes from the main body portion to at least one side in the first direction, and a second liquid injection frame in which a part of the liquid injection frame protrudes from the main body portion to at least the other side in the first direction.

### TECHNICAL FIELD

An aspect of the present invention relates to a power storage module and a power storage device.

### BACKGROUND ART

There is known a power storage module including a stacked body in which battery cells including an electrode plate, a positive electrode provided on one surface of the electrode plate, and a negative electrode provided on the other surface of the electrode plate are stacked (for example, Patent Document 1). In the power storage module, the periphery of the stacked body is surrounded by a sealing material (sealing portion) formed from a resin. A liquid injection port (a communication path communicating with the inside and the outside of the battery cells) configured to inject an electrolytic solution to the inside of the battery cells of the power storage module is formed in a side surface of the sealing portion formed from a resin along a stacking direction of the stacked body (main body portion of the power storage module).

### CITATION LIST

### Patent Literature

Patent Document 1: Japanese Unexamined Patent Publication No. 2012-234823

### SUMMARY OF INVENTION

### Technical Problem

It is preferable that injection of the electrolytic solution into the battery cells is performed in a state in which a gap between the liquid injection port provided in the side surface of the main body portion of the power storage module and an attachment configured to inject the electrolytic solution is sealed (airtightness is maintained). Here, in order to secure airtightness between the liquid injection port and the attachment attached to the liquid injection port, it is considered that a frame functioning as a sealing surface is formed at the periphery of each liquid injection port of the power storage module. At this time, a frame that is formed to surround a liquid injection port connected to the outermost cell of the power storage module protrudes from the main body portion of the power storage module in the stacking direction when viewed from a side surface of the power storage module. As a result, the size of the power storage module in the stacking direction at the periphery of the liquid injection port becomes larger than the size of the other portions in the stacking direction. In a power storage device constituted by stacking a plurality of power storage modules with locally different thicknesses, since modules adjacent to each other in the stacking direction are arranged with a predetermined interval so as not to come into contact with each other, the size of the power storage device in the stacking direction increases.

Here, an object of an aspect of the invention is to provide a power storage module capable of suppressing an increase in size in a stacking direction when being assembled into a power storage device even in a case where a frame is provided at the periphery of a liquid injection port configured to inject an electrolytic solution, and the power storage device.

### Solution to Problem

According to an aspect of the invention, there is provided a power storage module that is used in a stacked power storage device. The power storage module includes: an electrode stacked body, in which a bipolar electrode including a positive electrode formed on a first surface of a current collector and a negative electrode formed on a second surface opposite to the first surface, is stacked along a first direction; and a sealing portion that forms an internal space between a plurality of current collectors adjacent to each other in the first direction and seals the internal space, wherein the sealing portion includes a main body portion that is a cylindrical body formed in a rectangular frame shape so as to surround the electrode stacked body when viewed from the first direction and is provided with a plurality of communication paths each communicating with a plurality of internal spaces in a side surface of the cylindrical body, and a liquid injection portion that is attached to the one side surface of the main body portion and includes a plurality of liquid injection ports each communicating with the communication paths, the liquid injection portion includes a plurality of liquid injection frames each independently surrounding an end portion of each of the plurality of communication paths arranged along the first direction and forming each of the liquid injection ports, the plurality of liquid injection frames being arranged on the one side surface of the main body portion in a second direction orthogonal to the first direction, the plurality of liquid injection frames arranged in the second direction include a first liquid injection frame in which a part of the liquid injection frame protrudes from the main body portion to at least one side in the first direction and a second liquid injection frame in which a part of the liquid injection frame protrudes from the main body portion to at least another side in the first direction, an amount of protrusion of the first liquid injection frames is larger than an amount of protrusion of the second liquid injection frame in terms of an amount of protrusion of the part of the liquid injection frame from the main body portion to the one side in the first direction, and an amount of protrusion of the second liquid injection frame is larger than an amount of protrusion of the first liquid injection frame in terms of an amount of protrusion of the part of the liquid injection frame from the main body portion to the other side in the first direction.

A power storage device is constituted by stacking a plurality of the power storage modules. In the power storage module according to the aspect of the invention, the liquid injection frame that forms the liquid injection portion for injecting an electrolytic solution protrudes from the main body portion in the first direction that is a stacking direction. However, the amount of protrusion of a part of the liquid injection frame from the main body portion to one side in the first direction is larger in the first liquid injection portion as compared with the second liquid injection portion, and the amount of protrusion of a part of the liquid injection frame from the main body portion to the other side in the first direction is larger in the second liquid injection portion as compared with the first liquid injection portion. According to this, it is possible to prevent parts protruding significantly from the main body portion from facing each other in the first direction, and to suppress an increase in the size in the stacking direction when being assembled into the power storage device.

In the power storage module according to the aspect of the invention, the part of the liquid injection frame in the first liquid injection frame may protrude from the main body portion only to the one side in the first direction, and the part of the liquid injection frame in the second liquid injection frame may protrude from the main body portion only to the other side in the first direction.

In the power storage module according to the aspect of the invention, a plurality of first liquid injection frames and a plurality of second liquid injection frames may be provided, and the first liquid injection frames are arranged consecutively in the second direction, and the second liquid injection frames may be arranged consecutively in the second direction.

In the power storage module according to the aspect of the invention, a plurality of the first liquid injection frames and a plurality of the second liquid injection frames may be provided, and the first liquid injection frames and the second liquid injection frames may be arranged alternately in the second direction.

In the power storage module according to the aspect of the invention, the liquid injection portion may further include an overhang portion that is connected to the main body portion and covers a part of both end surfaces of the electrode stacked body in the first direction.

In the power storage module according to the aspect of the invention, a laminate film that covers the liquid injection ports may be attached to the liquid injection frames.

In the power storage module according to the aspect of the invention, when the positive electrode constituting one end portion of the stacked body in the first direction is set as a termination positive electrode and the negative electrode constituting another end portion of the stacked body in the first direction is set as a termination negative electrode in the stacked body, an exposed surface exposed to the outside may be formed on one surface of the current collector on which the positive electrode is not formed in the termination positive electrode and on one surface of the current collector on which the negative electrode is not formed in the termination negative electrode.

According to another aspect of the invention, there is provided a power storage device including: a plurality of the power storage modules; and a conductive plate having electrical conductivity, in which the power storage modules are stacked in the first direction via the conductive plate that is in contact with the exposed surface.

In the power storage device according to the aspect of the invention, when stacking the plurality of power storage modules so that the one side is a vertically upward side and the other side is a vertically downward side and so that the first liquid injection frame is arranged along the vertical direction and the second liquid injection frame is arranged along the vertical direction,
a lower end of the second liquid injection frame in one of the power storage modules may be located on a lower side of an upper end of the first liquid injection frame in the other power storage module when viewing the power storage modules adjacent to each other in the vertical direction.

### Advantageous Effects of Invention

According to the aspect of the invention, even in a case where a frame is provided at the periphery of a liquid injection port configured to inject an electrolytic solution, it is possible to suppress an increase in size in a stacking direction when being assembled into a power storage device.

### BRIEF DESCRIPTION OF DRAWINGS

FIG. 1 is a side view of a power storage module of an embodiment when viewed from an X-axis direction.

FIG. 2 is a top view of the power storage module according to the embodiment when viewed from an upward side of the power storage module in a Z-axis direction.

FIG. 3 is a cross-sectional view when viewed from line III-III shown in FIG. 1 and FIG. 2.

FIG. 4 is a side view of a power storage device in which the power storage module in FIG. 1 is stacked when viewed from the X-axis direction.

FIG. 5 is a schematic cross-sectional configuration view when viewed from line V-V shown in the power storage device in FIG. 4.

FIG. 6 is a side view of a power storage module according to a modification example when viewed from the X-axis direction.

### DESCRIPTION OF EMBODIMENTS

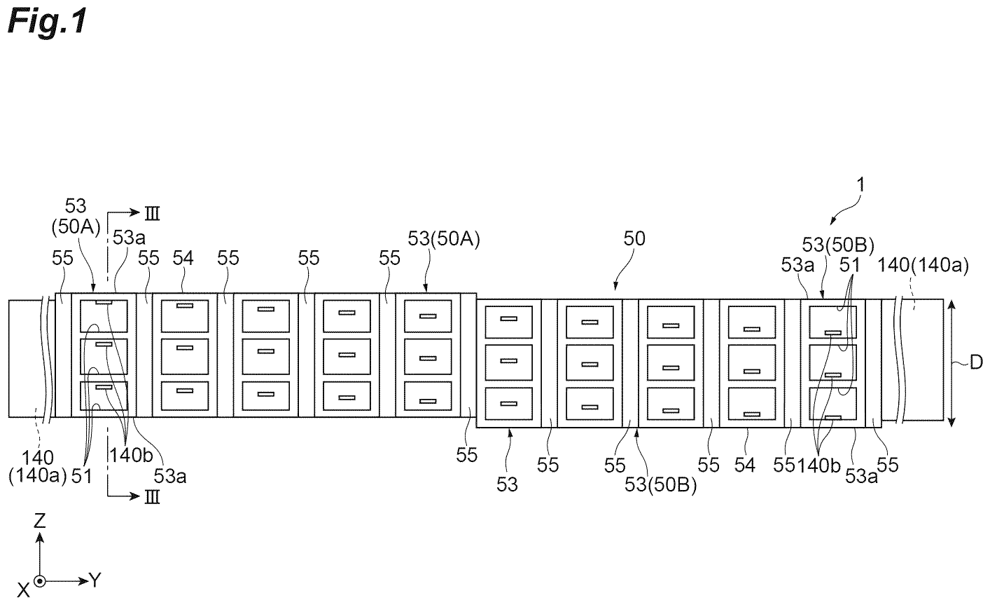

Hereinafter, an embodiment according to an aspect of the invention will be described in detail with reference to the accompanying drawings. In description of the drawings, the same reference numeral will be used for the same or equivalent element, and redundant description will be omitted. In FIG. 1 to FIG. 6, an XYZ orthogonal coordinate system orthogonal to each other is shown. An X-axis direction, a Y-axis direction (second direction), and a Z-axis direction (first direction) are orthogonal to each other.

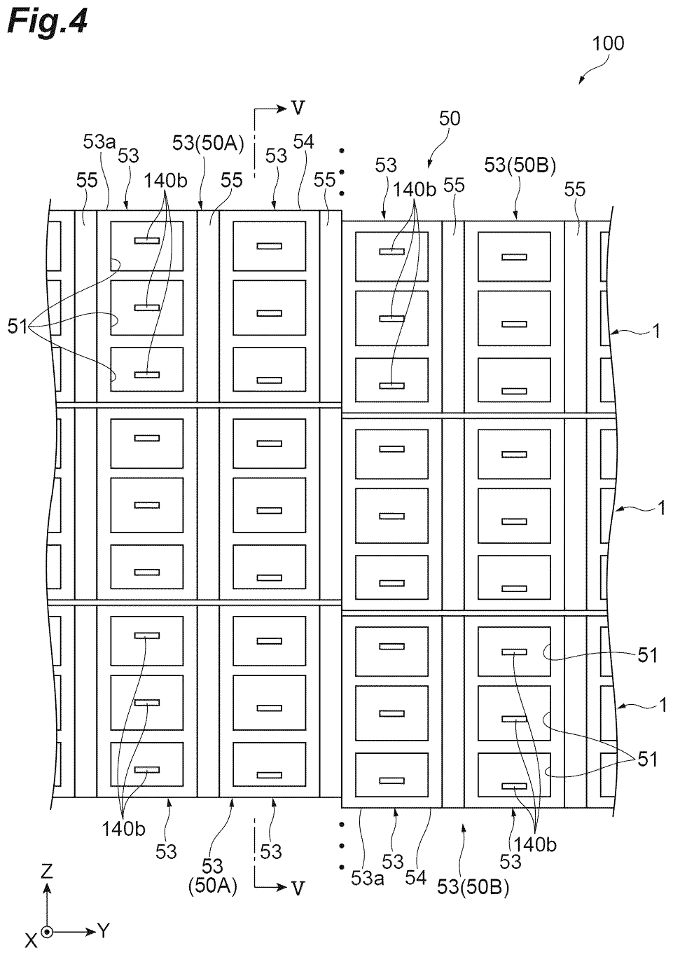

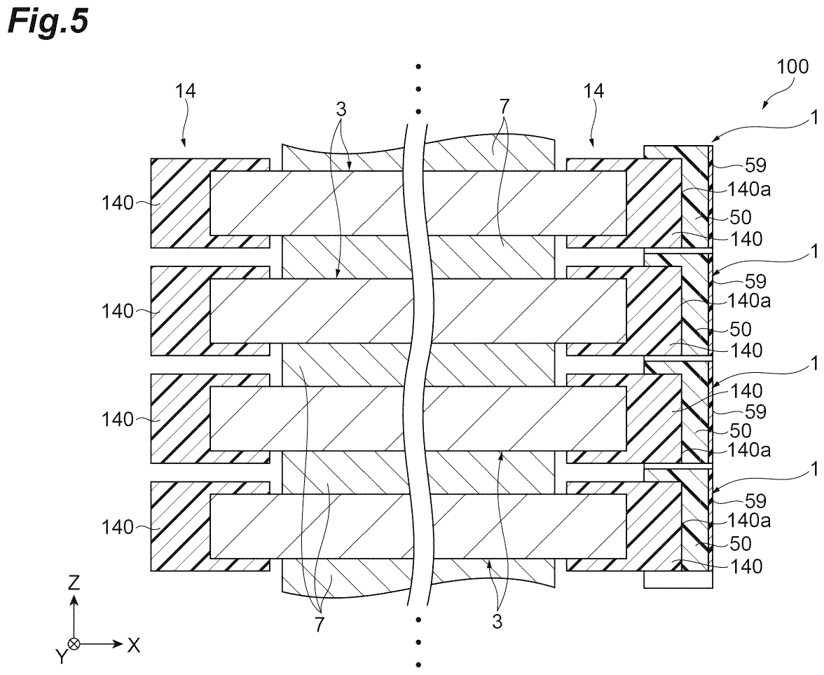

A power storage module 1 shown in FIG. 1 to FIG. 3 is included in a power storage device (stacked power storage device) 100 (refer to FIG. 4 and FIG. 5) that is used as a battery of various vehicles such as forklifts, hybrid vehicles, and electric vehicles. The power storage module 1 is, for example, a secondary battery such as a nickel-hydrogen secondary battery or a lithium-ion secondary battery. In this embodiment, a case where the power storage module 1 is the lithium-ion secondary battery is illustrated.

The power storage device 100 includes an electrode stacked body 3 in which a plurality of power storage cells 2 are stacked. Each of the power storage cells 2 includes a positive electrode 11, a negative electrode 12, a separator 13, and a sealing portion 14. The positive electrode 11 and the negative electrode 12 are disposed to face each other. A facing direction of the positive electrode 11 and the negative electrode 12 matches a stacking direction (first direction) D (Z-axis direction) of the plurality of power storage cells 2. The positive electrode 11 and the negative electrode 12 are, for example, rectangular electrodes when viewed from the stacking direction D. The power storage cells 2 may be a large-sized batteries in which one side is greater than 1 m.

The positive electrode 11 includes a current collector 21 and a positive electrode active material layer 23. The current collector 21 includes a first surface 21a and a second surface 21b facing opposite to each other, and an edge portion 21c. The positive electrode active material layer 23 is provided on the first surface 21a. The positive electrode active material layer 23 is not provided on the second surface 21b. The positive electrode active material layer 23 is not provided in the edge portion 21c on any of the first surface 21a side and the second surface 21b side. In other words, the first surface 21a includes a region where the positive electrode active material layer 23 is not provided in the edge portion 21c. The edge portion 21c is located on an outer side of a region where the positive electrode active material layer 23 is provided in the current collector 21 when viewed from the stacking direction D. The positive electrode 11 may be a large-sized electrode in which one side is greater than 1 m.

The negative electrode 12 includes a current collector 22 and a negative electrode active material layer 24. The current collector 22 includes a first surface 22a and a second surface 22b facing opposite to each other, and an edge portion 22c. The negative electrode active material layer 24 is provided on the first surface 22a. The negative electrode active material layer 24 faces the positive electrode active material layer 23 in the stacking direction D. The negative electrode active material layer 24 is not provided on the second surface 22b. The negative electrode active material layer 24 is not provided in the edge portion 22c on any of the first surface 22a side and the second surface 22b side. In other words, the first surface 22a includes a region where the negative electrode active material layer 24 is not provided in the edge portion 22c. The edge portion 22c is located on an outer side of a region where the negative electrode active material layer 24 is provided when viewed from the stacking direction D. The negative electrode 12 may be a large-sized electrode in which one side is greater than 1 m.

The positive electrode 11 and the negative electrode 12 are disposed so that the positive electrode active material layer 23 and the negative electrode active material layer 24 face each other in the stacking direction D. In this embodiment, any of the positive electrode active material layer 23 and the negative electrode active material layer 24 is formed in a rectangular shape when viewed from the stacking direction D. The negative electrode active material layer 24 is formed to be smaller than the positive electrode active material layer 23 by one turn. When viewed from the stacking direction D, the entirety of the positive electrode active material layer 23 is located on an outer side of an outer edge of the negative electrode active material layer 24.

The electrode stacked body 3 is constituted by stacking the plurality of power storage cells 2 so that the second surface 21b of the current collector 21 of one power storage cell 2 and the second surface 22b of the current collector 22 of another power storage cell 2 come into contact with each other. According to this, the plurality of power storage cells 2 are electrically connected in series. In the power storage cells 2 and 2 adjacent to each other in the stacking direction D, the current collector 21 of one power storage cell 2 and the current collector 22 of the other power storage cell 2 come into contact with each other, and are electrically connected to each other. For example, the electrode stacked body 3 may be obtained by stacking thirty power storage cells 2.

In the electrode stacked body 3, a pseudo bipolar electrode 10 in which the current collector 21 and the current collector 22 in contact with each other form one current collector is formed by power storage cells 2 and 2 adjacent to each other in the stacking direction D. A termination positive electrode including the current collector 21 is disposed at one end of the electrode stacked body 3 in the stacking direction D. A termination negative electrode including the current collector 22 is disposed at the other end of the electrode stacked body 3 in the stacking direction D. The termination negative electrode provided at the one end of the electrode stacked body 3 in the stacking direction D may include the current collector 22, and the termination negative electrode provided at the other end of the electrode stacked body 3 in the stacking direction D may include the current collector 21.

The current collectors 21 and 22 are chemically inactive electrical conductors for continuously causing a current to pass through the positive electrode active material layer 23 and the negative electrode active material layer 24 during discharging or charging of a lithium ion secondary battery. As a material constituting the current collectors 21 and 22, for example, a metallic material, a conductive resin material, a conductive inorganic material, and the like can be used. Examples of the conductive resin material include a resin in which a conductive filler is added to a conductive polymer material or a non-conductive polymer material, and the like. The current collectors 21 and 22 may be provided with a plurality of layers including one or more layers containing the above-described metallic material or conductive resin material. A coating layer may be formed on surfaces of the current collectors 21 and 22 by a known method such as a plating treatment or a spray coating. For example, the current collectors 21 and 22 may be formed in a shape such as a plate shape, a foil shape, a sheet shape, a film shape, and a mesh shape. In a case where the current collectors 21 and 22 formed as metal foil, for example, aluminum foil, copper foil, nickel foil, titanium foil, stainless stee foil, or the like can be used. The current collectors 21 and 22 may be alloy foil or clad foil of the metal. In a case where the current collectors 21 and 22 have the foil shape, the thickness of the current collectors 21 and 22 may be within a range of 1 μm or more and 100 μm or less. For example, the current collectors 21 and 22 may be integrated with each other by plating copper on each surface of aluminum foil. In addition, the current collectors 21 and 22 may be integrated with each other by bonding. In addition, the current collectors 21 and 22 may be subjected to a surface coating treatment such as vapor deposition and plating. In this embodiment, the current collector 1 is aluminum foil, and the current collector 22 is copper foil.

The positive electrode active material layer 23 contains a positive electrode active material capable of occluding and discharging a charge carrier such as lithium ions. Examples of the positive electrode active material include a composite oxide, metallic lithium, sulfur, and the like. A composition of the composite oxide contains, for example, at least one of iron, manganese, titanium, nickel, cobalt, aluminum, and lithium. Examples of the composite oxide include olivine-type lithium iron phosphate (LiFePO₄), LiCoO₂, LiNiMnCoO₂, and the like.

The negative electrode active material layer 24 contains a negative electrode active material capable of occluding and discharging a charger carrier such as lithium ions. Examples of the negative electrode active material include carbon such as graphite, artificial graphite, highly oriented graphite, mesocarbon microbeads, hard carbon, and soft carbon, metal compounds, elements or compounds thereof that can be alloyed with lithium, boron-added carbon, and the like. Examples of the elements that can be alloyed with lithium include silicon and tin.

The positive electrode active material layer 23 and the negative electrode active material layer 24 may contain a binding agent and a conductive auxiliary agent in addition to an active material. The binding agent plays a role of connecting the active material or the conductive auxiliary agent to maintain a conductive network in an electrode. Examples of the binding agent include fluorine-containing resins such as polyvinylidene fluoride, polytetrafluoroethylene, and fluorine rubber, thermoplastic resins such as polypropylene and polyethylene, imide resins such as polyimide and polyamideimide, alkoxysilyl group-containing resins, acrylic resins such as polyacrylic acid and polymethacrylic acid, styrene-butadiene rubber, carboxymethyl cellulose, alginates such as sodium alginate and ammonium alginate, water-soluble cellulose ester crosslinked bodies, and starch-acrylic acid graft polymers. The binding agents may be used alone or in combination. The conductive auxiliary agent is, for example, a conductive material such as acetylene black, carbon black, and graphite, and can increase electrical conductivity. As a viscosity adjusting solvent, for example, N-methyl-2-pyrrolidone or the like is used.

In order to form the positive electrode active material layer 23 and the negative electrode active material layer 24 on the first surfaces 21a and 22a, for example, a known method in the related art such as roll coating, die coating, dip coating, doctor blade, spray coating, and curtain coating is used. Specifically, an active material, a solvent, and as necessary, a binding agent and a conductive auxiliary agent are mixed to produce a slurry-like active material layer forming composition, and the active material layer forming composition is applied to the first surfaces 21a and 22a and dried. Examples of the solvent include N-methyl-2-pyrrolidone, methanol, methyl isobutyl ketone, and water. The resultant dried product may be compressed to increase an electrode density.

The separator 13 is disposed between the positive electrode 11 and the negative electrode 12 in the stacking direction D. The separator 13 is interposed between the positive electrode 11 and the negative electrode 12. The separator 13 is a member that isolates the positive electrode 11 and the negative electrode 12 adjacent to each other when stacking the power storage cells 2, and allows a charge carrier such as lithium ions to pass therethrough while preventing electrical short-circuit due to contact of both the electrodes. The separator 13 is disposed between the positive electrode active material layer 23 and the negative electrode active material layer 24 facing each other.

The separator 13 is formed in a rectangular shape that is larger than the positive electrode active material layer 23 and the negative electrode active material layer 24 by one turn and is smaller than the current collectors 21 and 22 by one turn when viewed from the stacking direction D. An end portion 13c of the separator 13 is disposed on an outer side of the positive electrode active material layer 23 and the negative electrode active material layer 24 when viewed from the stacking direction D. The end portion 13c of the separator 13 does not overlap any of the positive electrode active material layer 23 and the negative electrode active material layer 24 when viewed form the stacking direction D.

The separator 13 is formed, for example, in a sheet shape. For separator 13 is, for example, a porous sheet or nonwoven fabric containing a polymer that absorbs and retains an electrolyte. Examples of a material constituting the separator 13 include polypropylene, polyethylene, polyolefin, and polyester. The separator 13 may have a single-layer structure or a multilayer structure. In the case of the multilayer structure, the separator 13 may include, for example, a base material layer and a pair of adhesive layers, and may be bonded and fixed to the positive electrode active material layer 23 and the negative electrode active material layer 24 by the pair of adhesive layers. The separator 13 may include a ceramic layer that serves as a heat-resistant layer. The separator 13 may be reinforced with a vinylidene fluoride resin compound.

The electrolyte impregnated in the separator 13 may be, for example, a liquid electrolyte (electrolytic solution 5) containing a non-aqueous solvent and an electrolyte salt dissolved in the non-aqueous solvent. When the separator 13 is impregnated with an electrolyte, known lithium salts such as LiClO₄, LiAsF₆, LiPF₆, LiBF₄, LiCF₃SO₃, LiN(FSO₂)₂, and LiN(CF₃SO₂)₂ may be used as the electrolyte salt. In addition, known solvents such as cyclic carbonates, cyclic esters, chain carbonates, chain esters, and ethers may be used as the non-aqueous solvent. Note that, two or more of these known solvent materials may be used in combination.

When the positive electrode 11 arranged in the outermost layer of the electrode stacked body 3, that is, the positive electrode 11 constituting one end of the electrode stacked body 3 in the stacking direction D is set as a termination positive electrode, and the negative electrode 12 constituting the other end of the electrode stacked body 3 in the stacking direction D is set as a termination negative electrode, exposed surfaces 21e and 22e exposed to the outside are formed on the second surface 21b of the current collector 21 on which the positive electrode active material layer 23 is not formed in the termination positive electrode, and on the second surface 22b of the current collector 22 on which the negative electrode active material layer 24 is not formed in the termination negative electrode. The exposed surfaces 21e and 22e are surfaces that come into contact with a conductive plate 7 when the power storage module 1 is stacked.

The sealing portion 14 is a member that seals an internal space S between the current collector 21 and the current collector 22. The sealing portion 14 has a frame shape when viewed from the stacking direction D, and surrounds the periphery of the positive electrode active material layer 23 and the negative electrode active material layer 24. The sealing portion 14 forms the internal space S between the current collector 21 and the current collector 22 which is defined from the outside for accommodating the electrolytic solution 5. In the power storage cells 2, the internal space S is defined by the current collector 21, the current collector 22, and the sealing portion 14. The electrolytic solution 5 is accommodated in the internal space S. The sealing portion 14 is formed from a resin material having electrolyte resistance such as acid-modified polyethylene (acid-modified PE), acid-modified polypropylene (acid-modified PP), polyethylene, or polypropylene. The sealing portion 14 has electrical insulation properties.

The sealing portion 14 includes a sealing main body portion (main body portion) 140 and a liquid injection portion 50. The sealing main body portion 140 includes a first resin portion 15, a second resin portion 16, and an end surface welding portion 17. The sealing main body portion 140 has a thickness in the X-axis direction and the Y-axis direction. The first resin portion 15, the second resin portion 16, and the end surface welding portion 17 have a frame shape when viewed from the stacking direction D. The first resin portion 15 is provided on edge portions of the current collector 21 and the current collector 22 in the bipolar electrode 10 so as to be separated from the positive electrode active material layer 23 and the negative electrode active material layer 24. That is, there is a space between an inner peripheral surface of the first resin portion 15 and an outer peripheral surface of the positive electrode active material layer 23, and there is a space between the inner peripheral surface of the first resin portion 15 and an outer peripheral surface of the negative electrode active material layer 24. The first resin portion 15 is provided to cover the first surface 21a of the current collector 21 and the first surface 22a of the current collector 22 at the edge portions of the current collector 21 and the current collector 22.

The first resin portion 15 is provided at the edge portion of the current collector 21 so as to be separated from the positive electrode active material layer 23 in the termination positive electrode constituting one end portion of the electrode stacked body 3 in the stacking direction D. That is, there is a space between the inner peripheral surface of the first resin portion 15 and the outer peripheral surface of the positive electrode active material layer 23. In addition, the first resin portion 15 is provided to cover the first surface 21a and the second surface 21b at the edge portion of the current collector 21. The first resin portion 15 is provided at the edge portion of the current collector 22 so as to be spaced apart from the negative electrode active material layer 24 at a termination negative electrode constituting the other end portion of the electrode stacked body 3 in the stacking direction D. That is, there is a space between the inner peripheral surface of the first resin portion 15 and the outer peripheral surface of the negative electrode active material layer 24. In addition, the first resin portion 15 is provided at an edge of the current collector 22 so as to cover the first surface 22a and the second surface 22b.

The second resin portion 16 is disposed between the first resin portion 15 and the first resin portion 15 in the Z-axis direction. The second resin portion 16 has a function as a joining portion that joins first resin portions 15 and 15 to each other, and a function as a space retention portion that retains the space between the first resin portions 15 and 15. As in each of the first resin portions 15, the second resin portion 16 is disposed to be spaced apart from the positive electrode active material layer 23 and the negative electrode active material layer 24. That is, there is a space between an inner peripheral surface of the second resin part 16 and the outer peripheral surface of the positive electrode active material layer 23, and there is a space between the inner peripheral surface of the second resin part 16 and the outer peripheral surface of the negative electrode active material layer 24. The second resin part 16 is joined to the first resin portion 15 by welding.

The end surface welding portion 17 welds an outer edge portion of the first resin portion 15 and an edge portion of the second resin portion 16 to integrate the first resin portion 15 and the second resin portion 16 with each other. The end surface welding portion 17 is formed on at least one of outer peripheral surfaces of the first resin portion 15 and the second resin portion 16 when viewed from the stacking direction D. The end surface welding portion 17 is formed in a region on an outer side of the outer edge portions of the current collectors 21 and 22 when viewed from the stacking direction D. In this embodiment, the end surface welding portion 17 is formed on all four surfaces forming outer peripheral surfaces which are the outer peripheral surfaces of the first resin portion 15 and the second resin portion 16. The thickness (length in a direction orthogonal to the first direction) of the end surface welding portion 17 on a surface in which a liquid injection port 51 is not formed may be larger than the thickness of the end surface welding portion 17 on a surface in which the liquid injection port 51 is formed.

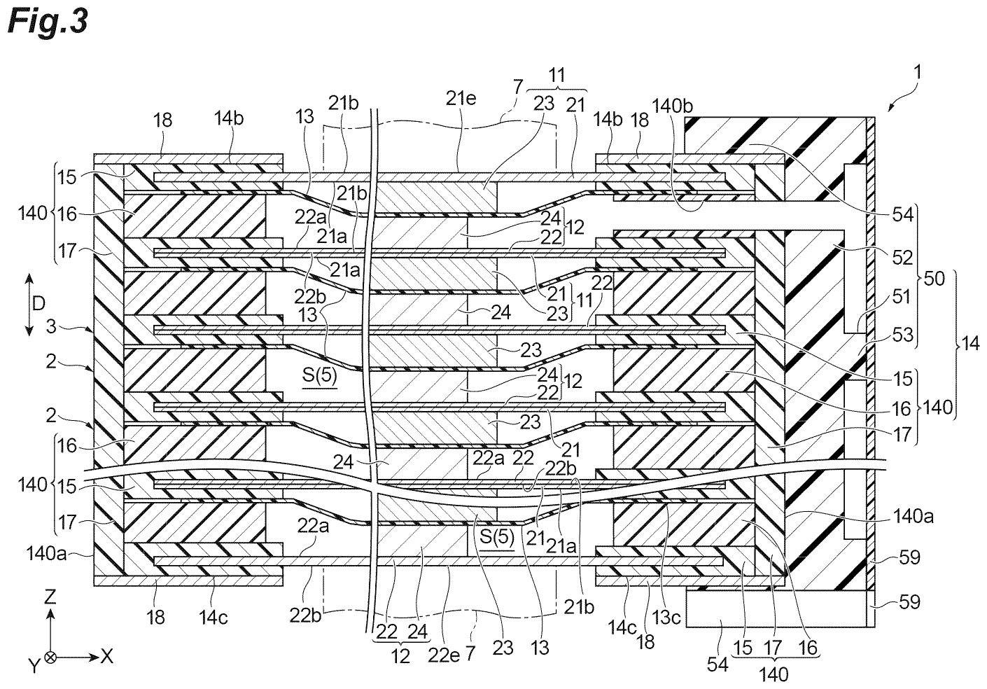

The sealing main body portion 140 is formed in a rectangular tube shape by integrating a plurality of the first resin portions 15 and the second resin portions 16 arranged in the stacking direction D of the electrode stacked body 3 by welding, and by welding the outer edge portion of the first resin portion 15 and the outer edge portion of the second resin portion 16 by the end surface welding portion 17. The sealing main body portion 140 of the sealing portion 14 forms a side surface 140a extending in the stacking direction D from the first resin portion 15 provided on the current collector 21 disposed at one end of the electrode stacked body 3 in the stacking direction D to the second resin portion 16 provided on the current collector 22 arranged at the other end in the stacking direction D. In other words, the sealing main body portion 140 is formed with four side surfaces 140a orthogonal to a direction (the X-axis direction and the Y-axis direction shown in FIG. 3) orthogonal to the stacking direction D (the Z-axis direction shown in FIG. 3). The side surfaces 140a of the sealing main body portion 140 are also side surfaces of the sealing portion 14 and also side surfaces of the power storage module 1.

As described above, the sealing main body portion 140 is a cylindrical body formed in a rectangular frame shape so as to surround the electrode stacked body 3 when viewed from the Z-axis direction. The sealing main body portion 140 has a thickness in the X-axis direction and the Y-axis direction. A side portion that forms one of the side surfaces 140a of the sealing main body portion 140 that is a cylindrical body is provided with a plurality of communication paths 140b each (respectively) communicating with a plurality of the internal spaces S. An opening (end portion) of the communication paths 140b is formed in one of the side surfaces 140a of the sealing main body portion 140.

The liquid injection portion 50 is provided to inject the electrolytic solution 5 into each of the internal spaces S inside the sealing portion 14. The liquid injection portion 50 is provided on one of the four side surfaces 140a. The liquid injection portion 50 is attached to the one side surface 140a of the sealing main body portion 140, and has a plurality of the liquid injection ports 51 each communicating with the communication paths 140b. The liquid injection portion 50 includes a liquid injection main body portion 52, a liquid injection frame 53, and an overhang portion 54. The liquid injection main body portion 52 is a portion that covers the side surface 140a. The liquid injection main body portion 52 of this embodiment covers a part of one side surface 140a among the four side surfaces 140a.

The liquid injection frame 53 protrudes from the liquid injection main body portion 52, and is provided to connect a connection portion of an injection device for the electrolytic solution 5 and the communication paths 140b in a sufficiently sealed state (maintaining airtightness) when the electrolytic 5 is injected into the internal spaces S of the power storage module 1. In other words, the liquid injection frame 53 has a frame-shaped sealing surface against which the connection portion of the liquid injection device is pressed. The frame-shaped sealing surface is formed to be flat in the X-axis direction, and is configured to be able to come into close contact with, for example, a rubber packing or the like provided in the injection device or the like for the electrolytic solution 5.

Here, a plurality of the communication paths 140b are provided in the Z-axis direction (first direction) of the sealing main body portion 140, and a plurality of communication path groups provided in the Z-axis direction (first direction) are provided in the Y-axis direction. In this embodiment, three communication paths 140b are arranged in the Z-axis direction, and ten communication path groups each including three communication paths 140b in the Z-axis direction are arranged along the Y-axis direction. The communication paths 140b are opened to the side surface 140a of the sealing main body portion 140 along the Z-axis direction, are also opened to the liquid injection main body portion 52 surrounded by the liquid injection frame 53, and communicate with the internal spaces S from the outside of the module.

The liquid injection frame 53 is formed in the liquid injection main body portion 52, and independently surrounds the opening of each of the plurality of communication paths 140b arranged along the Z-axis direction, thereby forming the liquid injection port 51. The liquid injection frame 53 of this embodiment is a frame that allows the communication paths 140b to be opened to (communicate with) the outside and forms the liquid injection port 51. More specifically, the liquid injection frame 53 protrudes from the liquid injection main body portion 52 so as to surround an end portion of one of the communication paths 140b. The liquid injection port 51 is formed from an inner peripheral surface (inner wall) of the liquid injection frame 53 that protrudes from the liquid injection main body portion 52 so as to surround the end portion of one of the communication paths 140b.

The liquid injection ports 51 are provided in correspondence with the communication paths 140b each provided for each of a plurality of the internal spaces S. More specifically, in the sealing portion 14 of the power storage module 1, ten liquid injection frames 53 each including three liquid injection ports 51 are arranged in the Y-axis direction. That is, the sealing portion 14 of the power storage module 1 is provided with 30 liquid injection ports 51. The shape of the liquid injection ports 51 when viewed from an extension direction (X-axis direction) of the liquid injection ports 51 is formed, for example, in a rectangular shape (rectangle) that is long in one direction (Y-axis direction). Note that, the shape of the liquid injection ports 51 is not limited, and may be formed, for example, in a circular shape or the like. The liquid injection ports 51 are sealed by a sealing portion after the electrolytic solution is injected.

Ten liquid injection frames 53 are formed on the side surface 140a of the sealing portion 14 in the Y-axis direction as described above. Each of the plurality of liquid injection frames 53 includes a first liquid injection frame 50A in which a part of the liquid injection frame 53 protrudes from the sealing main body portion 140 only to one side in the stacking direction D (Z-axis direction), and a second liquid injection frame 50B in which a part of the liquid injection frame 53 protrudes from the sealing main body portion 140 only to the other side in the stacking direction D (Z-axis direction). In other words, there are at least two types of liquid injection frames among the plurality of liquid injection frames 53. Note that, a configuration in which a part of the liquid injection frame 53 protrudes from the sealing main body portion 140 represents that a part of an outer shape 53a of the liquid injection frame 53 protrudes from the sealing main body portion 140 in the stacking direction D (Z-axis direction) when viewed from the X-axis direction.

As illustrated in FIG. 3, in the first liquid injection frame 50A, an upper portion constituting the liquid injection frame 53 may protrude from the sealing main body portion 140 in the stacking direction D, and the amount of protrusion of a lower portion constituting the liquid injection frame 53 from the sealing main body portion 140 in the stacking direction D may be smaller as compared with the upper portion constituting the liquid injection frame 53. The lower portion constituting the liquid injection frame 53 may not protrude from the sealing main body portion 140 in the stacking direction D. In the second liquid injection frame 50B, a lower portion constituting the liquid injection frame 53 may protrude from the sealing main body portion 140 in the stacking direction D, and the amount of protrusion of an upper portion constituting the liquid injection frame 53 from the sealing main body portion 140 in the stacking direction D may be smaller as compared with the lower portion constituting the liquid injection frame 53. The upper portion constituting the liquid injection frame 53 may not protrude from the sealing main body portion 140 in the stacking direction D.

In this embodiment, some of the plurality of liquid injection frames 53 provided in the power storage module 1 are the first liquid injection frames 50A in which a part of the liquid injection frame 53 protrudes from the sealing main body portion 140 only to one side in the stacking direction D, and the plurality of remaining liquid injection frames 53 are the second liquid injection frames 50B in which a part of the liquid injection frame 53 protrudes from the sealing main body portion 140 only to the other side in the stacking direction D. In other words, in the power storage module 1, liquid injection frames 53 other than the first liquid injection frames 50A and the second liquid injection frames 50B do not exist. Furthermore, the power storage module 1 of this embodiment is provided with the same number of first liquid injection frames 50A and second liquid injection frames 50B. Specifically, five first liquid injection frames 50A and five second liquid injection frames 50B are provided.

As described above, the power storage module 1 has four side surfaces 140a, and the plurality of liquid injection frames 53 are formed on one of the side surfaces 140a and are arranged along the Y-axis direction orthogonal to the stacking direction D (Z-axis direction). In this embodiment, in the Y-axis direction, five first liquid injection frames 50A are arranged consecutively, and five second liquid injection frames 50B are arranged consecutively. Note that, a connection portion 55 is formed between adjacent liquid injection frames 53 and 53. The connection portion 55 has a surface that is formed to be flush with the sealing surface of the liquid injection frame 53 in the X-axis direction.

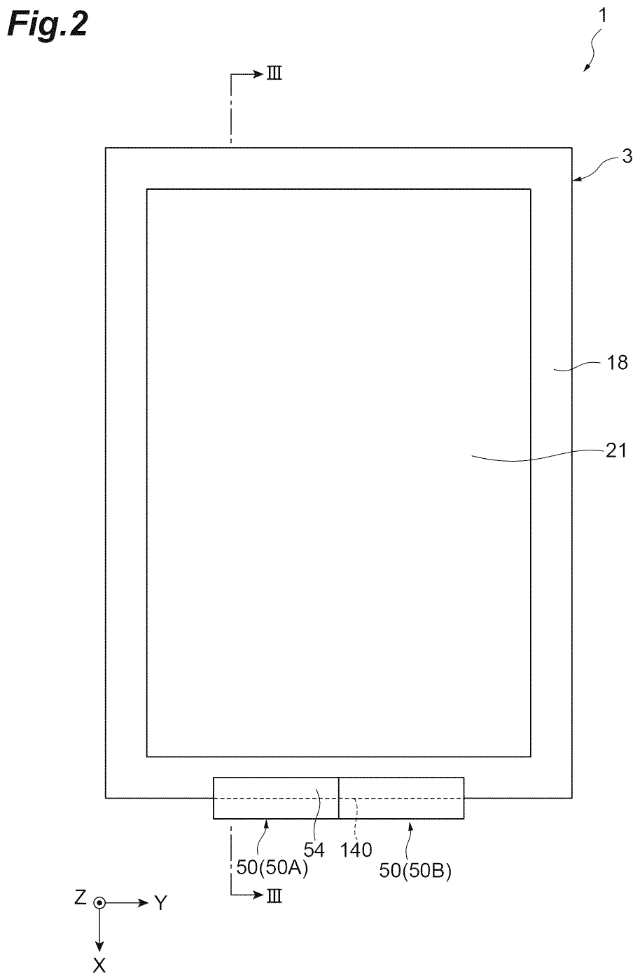

A laminate film 59 (refer to FIG. 3) that covers the liquid injection port 51 is attached to the liquid injection frame 53. As the laminate film 59, for example, a known composite laminate film in which metal foil and a resin layer are bonded to each other can be used. For example, metals such as aluminum, an aluminum alloy, stainless steel, or a nickel alloy can be used for the metal foil of the composite laminate film. For example, resins such as polyethylene, ethylene vinyl acetate, or polyethylene terephthalate can be used for the resin layer of the composite laminate film. The laminate film 59 is not illustrated in FIGS. 1 and 2.

The liquid injection frame 53 can be formed integrally with the sealing portion 14 by, for example, injection molding. The liquid injection portion 50 includes the overhang portion (build-up portion) 54 that overlaps the sealing main body portion 140 when viewed from the stacking direction D. The overhang portion 54 is connected to the sealing main body portion 140 and covers a part of both end surfaces of the electrode stacked body 3 in the stacking direction D. The liquid injection frame 53 and the overhang portion 54 may be connected to the sealing main body portion 140 by welding. The liquid injection frame 53 and the overhang portion 54 may be formed simultaneously over the sealing main body portion 140 by injection molding.

A sheet member 18 including a metal layer is attached to frame-shaped first surface 14b and second surface 14c formed at both ends of the electrode stacked body 3, which are surfaces of the sealing portion 14 orthogonal to the stacking direction D. Furthermore, the sheet member 18 is also attached to an outer surface of the liquid injection frame 53 forming the liquid injection portion 50 formed on the side surface 140a of the sealing portion 14. In this configuration, the metal layer included in the sheet member 18 is a material having a lower hydrogen or moisture permeability coefficient as compared with a resin. For this reason, the sheet member 18 has high barrier properties against moisture, and thus intrusion of moisture into the power storage module through the sealing portion 14 is further suppressed as compared with a case where the sealing portion 14 is made of only a resin material.

Here, the sheet member 18 may be a laminate film. As the laminate film, for example, a known composite laminate film in which metal foil and a resin layer are bonded can be used. For example, a metal such as aluminum, an aluminum alloy, stainless steel, or a nickel alloy can be used for the metal foil of the composite laminate film. For example, a resin such as polyethylene, ethylene vinyl acetate, or polyethylene terephthalate can be used for the resin layer of the composite laminate film.

As illustrated in FIG. 4 and FIG. 5, the power storage device 100 is configured by stacking the above-described power storage modules 1 in the Z-axis direction and electrically connecting the plurality of power storage modules 1 in series. More specifically, the power storage device 100 is configured by contacting and arranging the conductive plate 7 on the exposed surfaces 21e and 22e formed on both ends of the power storage module 1, and stacking the power storage modules 1 via the conductive plate 7. In the power storage device 100, the plurality of liquid injection portions 50 formed on the side surface 140a of each of the plurality of power storage modules 1 are arranged so as to be aligned in the Z-axis direction. In other words, the liquid injection portions 50 of the power storage modules 1 constituting the power storage device 100 are arranged so as to be aligned on a straight line in the Z-axis direction, and are arranged in a lattice pattern when viewed from the X-axis direction. Note that, in FIG. 5, the communication path 140b and the liquid injection port 51 are not illustrated.

More specifically, in the power storage device 100, the plurality of the power storage modules 1 are stacked so that a direction in which the first liquid injection frames 50A protrude from the sealing main body portion 140 (one side in the first direction) is vertically upward side and a direction in which the second liquid injection frames 50B protrude from the sealing main body portion 140 (the other side in the first direction) is vertically downward side, and so that the first liquid injection frames 50A are arranged along the vertical direction and the second liquid injection frames 50B are arranged along the vertical direction.

In addition, when viewing the vertically adjacent power storage modules 1 and 1, in the first liquid injection frames 50A arranged in the stacking direction D, a gap is provided between a lower end of the first liquid injection frames 50A in one power storage module 1 and an upper end of the first liquid injection frames 50A in the other power storage module 1. Moreover, when viewing the vertically adjacent power storage modules 1, in the second liquid injection frames 50B arranged in the stacking direction D, a gap is provided between a lower end of the second liquid injection frames 50B in one power storage module 1 and an upper end of the second liquid injection frames 50B in the other power storage module 1. These two gaps are provided by adjusting the thickness of the conductive plate 7 disposed between the power storage modules 1 and 1 adjacent to each other in the stacking direction D. According to this, it is possible to suppress occurrence of electrical contact failure between the modules and the conductive plate due to contact between the liquid injection frames 53 and 53 of the modules adjacent to each other in the stacking direction D.

In addition, in the power storage device 100, when viewing the power storage modules 1 adjacent to each other in the stacking direction from the X-axis direction, the lower end of the second liquid injection frames 50B in one power storage module 1 is located on a lower side of the upper end of the first liquid injection frames 50A in the other power storage module 1. As a result, due to a step difference between the first liquid injection frames 50A and the second liquid injection frames 50B in the stacking direction D, when one of the power storage modules 1 and 1 adjacent to each other in the stacking direction D (Z-axis direction) moves in a lateral direction (in the Y-axis direction), a protruding portion of one storage modules 1 comes into contact with a protruding portion of the other power storage module 1. According to this, it is possible to restrict the power storage modules 1 and 1 from moving in the Y-axis direction orthogonal to the stacking direction D. In other words, this configuration can be used for positioning when stacking the power storage modules 1.

Operational effects of the power storage module 1 and the power storage device 100 of the above embodiment will be described. The power storage device 100 of the above embodiment is configured by stacking the plurality of power storage modules 1. In the power storage modules 1 of this embodiment, the liquid injection frame 53 provided in the liquid injection portion 50 for injecting the electrolytic solution 5 is set to protrude from the sealing main body portion 140 in the Z-axis direction that is the stacking direction D. However, the amount of protrusion of a part of the liquid injection frame 53 from the sealing main body portion 140 to an upper side in the Z-axis direction is larger in the first liquid injection frame 50A as compared with the second liquid injection frame 50B, and the amount of protrusion of a part of the liquid injection frame 53 from the sealing main body portion 140 to a lower side in the Z-axis direction is larger in the second liquid injection frame 50B as compared with the first liquid injection frame 50A. According to this, it is possible to prevent the parts protruding significantly from the sealing main body portion 140 from facing each other in the stacking direction D, and to suppress an increase in the size in the stacking direction D when being assembled into the power storage device 100.

In the power storage module 1 of the above-described embodiment, the plurality of liquid injection frames 53 include the first liquid injection frame 50A in which a part protrudes from the sealing main body portion 140 only to the upper side in the Z-axis direction, and the second liquid injection frame 50B in which a part protrudes from the sealing main body portion 140 only to the lower side in the Z-axis direction. In other words, in each of the first liquid injection frame 50A and the second liquid injection frame 50B in the above-described embodiment, one side (upper side or lower side) of a part thereof does not protrude from the sealing main body portion 140 in the Z-axis direction. According to this, it is possible to prevent the parts that largely protrude from the sealing main body portion 140 from facing each other in the stacking direction D, and it is possible to suppress an increase in the size in the stacking direction when being assembled into the power storage device 100.

In the power storage module 1 of the above-described embodiment, only the first liquid injection frame 50A and the second liquid injection frame 50B are provided as the liquid injection frame 53. According to this, it is possible to limit a configuration of the liquid injection frame 53 to a configuration of the first liquid injection frame 50A and a configuration of the second liquid injection frame 50B, thereby improving the productivity of the power storage module 1. Furthermore, in the power storage module 1 of the above-described embodiment, the same number of first liquid injection frames 50A and second liquid injection frames 50B are provided, and thus symmetry is secured and excellent balance is achieved when a plurality of the power storage modules 1 are stacked.

In the power storage module 1 of the above-described embodiment, four side surfaces 140a are formed in the frame-shaped sealing portion 14, and the plurality of liquid injection frames 53 are formed on one of the side surfaces 140a and arranged along the Y-axis direction orthogonal to the stacking direction D as illustrated in FIG. 2 and FIG. 3. According to this, it is easier to inject the electrolytic solution 5 as compared with a power storage module 1 in which the liquid injection frames 53 are formed and distributed over a plurality of side surfaces 140a.

In the power storage module 1 of the above-described embodiment, as illustrated in FIG. 2 and FIG. 4, the first liquid injection frames 50A are arranged consecutively in the Y-axis direction, and the second liquid injection frames 50B are arranged consecutively in the Y-axis direction. In this configuration, due to the step difference between the first liquid injection frames 50A and the second liquid injection frames 50B, the power storage modules 1 and 1 adjacent to each other in the stacking direction D can be prevented from moving in the Y-axis direction.

In the power storage module 1 of the above-described embodiment, the metal sheet member 18 is attached to the frame-shaped first surface 14b and second surface 14c of the sealing portion 14, which are surfaces orthogonal to the stacking direction D and are arranged at both ends of the electrode stacked body 3. Since the metal sheet member 18 has a lower moisture permeability coefficient as compared with a resin, intrusion of moisture into the sealing portion 14 is further suppressed as compared with a configuration consisting of the sealing portion 14.

In the power storage module 1 of the above-described embodiment, the exposed surfaces 21e and 22e exposed to the outside are respectively formed in the second surface 21b of the current collector 21 constituting the positive electrode 11 and the second surface 22b of the current collector 22 constituting the negative electrode 12, the positive electrode 11 and the negative electrode being arranged at both ends of the electrode stacked body 3. In the power storage module 1 having this configuration, a plurality of the power storage modules 1 can be electrically connected in series simply by a simple task of stacking the power storage modules 1 in a state in which the conductive plate 7 is in contact with the exposed surfaces 21e and 22e.

In the power storage module 1 of the above-described embodiment, the liquid injection portion 50 further includes that overhang portion 54 that is connected to the sealing main body portion 140 and covers a part of both end surfaces of the electrode stacked body 3 in the stacking direction D (Z-axis direction). According to this, the liquid injection portion 50 can be provided more stably with respect to the sealing main body portion 140.

In the power storage module 1 of the above-described embodiment, the laminate film 59 that covers the liquid injection port 51 is attached to the first liquid injection frame 50A and the second liquid injection frame 50B. According to this, not only the liquid injection port 51 but also the communication path 140b is sealed to block communication between the internal space S and the outside.

Hereinbefore, although one embodiment has been described, an aspect of the invention is not limited to the above-described embodiment, and various modifications can be made within a range not departing from the gist of the invention.

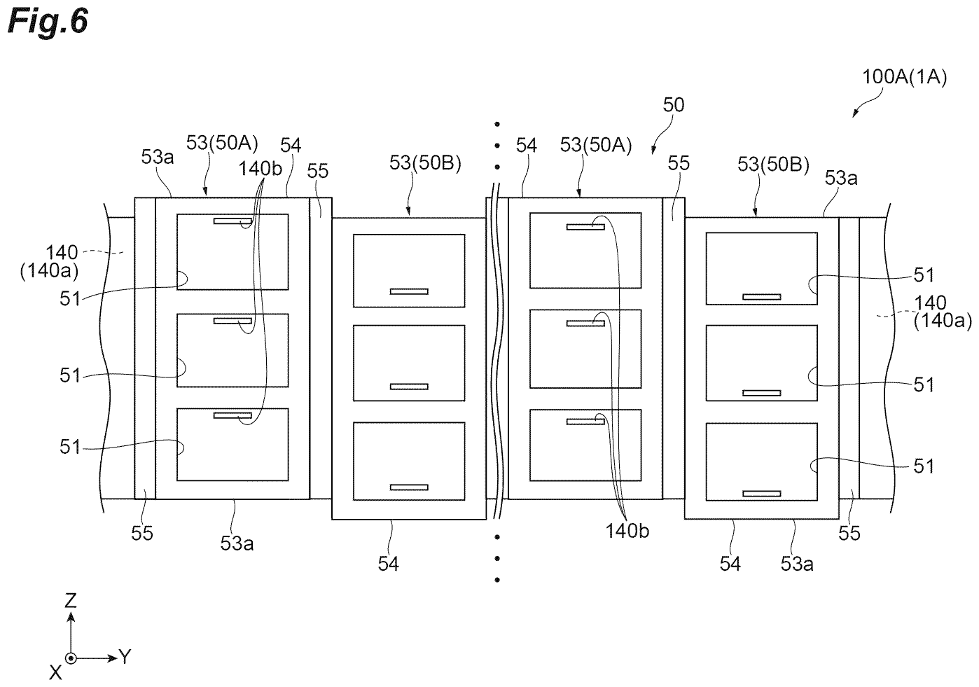

in the above-described embodiment, as illustrated in FIG. 4, description has been given of an example in which the first liquid injection frames 50A are consecutively arranged in the Y-axis direction orthogonal to the stacking direction D, and the second liquid injection frames 50B are consecutively arranged in the Y-axis direction, but an aspect of the invention is not limited to the example. For example, in a power storage module 1A according to a modification example, the first liquid injection frames 50A and the second liquid injection frames 50B may be alternately arranged in the Y-axis direction as illustrated in FIG. 6. In a configuration of a power storage device 100A in which the power storage module 1 of this modification example is stacked, due to step differences of the first liquid injection frame 50A and the second liquid injection frame 50B, the second liquid injection frame 50B is fitted into the step difference between a pair of the first liquid injection frames 50A and 50A, and the first liquid injection frame 50A is fitted into the step difference between a pair of second liquid injection frames 50B, 50B. According to this, it is possible to restrict the power storage modules 1 and 1 adjacent to each other in the stacking direction D from moving in the Y-axis direction.

Note that, in FIG. 6, description has been given of an example in which the metal sheet member 18 is not disposed, but the metal sheet member 18 may be attached to the frame-shaped first surface 14b and second surface 14c formed on both ends of the electrode stacked body 3.

In the above-described embodiment and modification example, description has been given of an example in which only the first liquid injection frame 50A and the second liquid injection frame 50B are provided on the side surface 140a of the sealing portion 14. However, in addition to the liquid injection frames 53, for example, a liquid injection portion 50 including a liquid injection frame 53 in which a part of the liquid injection frame 53 does not protrude from the sealing main body portion 140 to both one side and the other side in the stacking direction D may be provided, or a liquid injection portion 50 including a liquid injection frame 53 in which a part of the liquid injection frame 53 protrudes from the sealing main body portion 140 to both one side and the other side in the stacking direction D may be provided.

The number of the liquid injection frames 53, the number of the liquid injection ports 51 formed in one of the liquid injection frames 53, and the number and arrangement of the first liquid injection frames 50A and the second liquid injection frames 50B illustrated in the above-described embodiment and the above-described modification example can be appropriately changed in accordance with the number of internal spaces S formed in the power storage module 1, and the like. For example, in the power storage module 1 arranged so that the stacking direction D conforms to the vertical direction, only one liquid injection frame 53 forming the liquid injection port 51 corresponding to the communication path 140b communicating with the internal space S arranged on the uppermost side may be set as the first liquid injection frame 50A, only one liquid injection frame 53 forming the liquid injection port 51 corresponding to the communication path 140b communicating with the internal space S arranged on the lowermost side may be set as the second liquid injection frame 50B, and the remaining liquid injection frames 53 may be configured as third liquid injection frames in which a part thereof does not protrude from the sealing main body portion 140 in the stacking direction D.

In the above-described embodiment and the above-described modification example, description has been given of an example in which all injection frames 53 are arranged on one side surface 140a among the plurality of side surfaces 140a in the sealing portion 14, but there is no limitation to the example, and for example, the plurality of liquid injection frames 53 may be distributed and arranged on the plurality of side surfaces 140a.

### REFERENCE SIGNS LIST

1, 1A: power storage module, 2: power storage cell, 3: electrode stacked body, 5: electrolytic solution, 7: conductive plate, 11: positive electrode, 12: negative electrode, 14: sealing portion, 18: sheet member, 21: current collector, 21e: exposed surface, 22: current collector, 22e: exposed surface, 50: liquid injection portion, 50A: first liquid injection frame, 50B: second liquid injection frame, 51: liquid injection port, 53: liquid injection frame, 100, 100A: power storage device, 140: sealing main body portion (main body portion), 140a: side surface, 140b: communication path, D: stacking direction (first direction), S: internal space.

1. A power storage module that is used in a stacked power storage device, comprising:
an electrode stacked body, in which a bipolar electrode including a positive electrode formed on a first surface of a current collector and a negative electrode formed on a second surface opposite to the first surface, is stacked along a first direction; and
a sealing portion that forms an internal space between a plurality of current collectors adjacent to each other in the first direction and seals the internal space,
wherein the sealing portion includes
a main body portion that is a cylindrical body formed in a rectangular frame shape so as to surround the electrode stacked body when viewed from the first direction and is provided with a plurality of communication paths each communicating with a plurality of internal spaces in a side surface of the cylindrical body, and
a liquid injection portion that is attached to the one side surface of the main body portion and includes a plurality of liquid injection ports each communicating with the communication paths,
the liquid injection portion includes a plurality of liquid injection frames each independently surrounding an end portion of each of the plurality of communication paths arranged along the first direction and forming each of the liquid injection ports, the plurality of liquid injection frames being arranged on the one side surface of the main body portion in a second direction orthogonal to the first direction,
the plurality of liquid injection frames arranged in the second direction include a first liquid injection frame in which a part of the liquid injection frame protrudes from the main body portion to at least one side in the first direction and a second liquid injection frame in which a part of the liquid injection frame protrudes from the main body portion to at least another side in the first direction,
an amount of protrusion of the first liquid injection frames is larger than an amount of protrusion of the second liquid injection frame in terms of an amount of protrusion of the part of the liquid injection frame from the main body portion to the one side in the first direction, and
an amount of protrusion of the second liquid injection frame is larger than an amount of protrusion of the first liquid injection frame in terms of an amount of protrusion of the part of the liquid injection frame from the main body portion to the other side in the first direction.

2. The power storage module according to claim 1,
wherein the part of the liquid injection frame in the first liquid injection frame protrudes from the main body portion only to the one side in the first direction, and
the part of the liquid injection frame in the second liquid injection frame protrudes from the main body portion only to the other side in the first direction.

3. The power storage module according to claim 1-or
wherein a plurality of first liquid injection frames and a plurality of second liquid injection frames are provided, and
the first liquid injection frames are arranged consecutively in the second direction, and the second liquid injection frames are arranged consecutively in the second direction.

4. The power storage module according to claim 1,
wherein a plurality of the first liquid injection frames and a plurality of the second liquid injection frames are provided, and
the first liquid injection frames and the second liquid injection frames are arranged alternately in the second direction.

5. The power storage module according to claim 1,
wherein the liquid injection portion further includes an overhang portion that is connected to the main body portion and covers a part of both end surfaces of the electrode stacked body in the first direction.

6. The power storage module according to claim 1,
wherein a laminate film that covers the liquid injection ports is attached to the liquid injection frames.

7. The power storage module according to claim 1,
wherein when the positive electrode constituting one end portion of the stacked body in the first direction is set as a termination positive electrode and the negative electrode constituting another end portion of the stacked body in the first direction is set as a termination negative electrode in the stacked body,
an exposed surface exposed to the outside is formed on one surface of the current collector on which the positive electrode is not formed in the termination positive electrode and on one surface of the current collector on which the negative electrode is not formed in the termination negative electrode.

8. A power storage device, comprising:
a plurality of power storage modules according to claim 7; and
a conductive plate having electrical conductivity,
wherein the power storage modules are stacked in the first direction via the conductive plate that is in contact with the exposed surface.

9. The power storage device according to claim 8,
wherein when stacking the plurality of power storage modules so that the one side is a vertically upward side and the other side is a vertically downward side and so that the first liquid injection frame is arranged along the vertical direction and the second liquid injection frame is arranged along the vertical direction,
a lower end of the second liquid injection frame in one of the power storage modules is located on a lower side of an upper end of the first liquid injection frame in the other power storage module when viewing the power storage modules adjacent to each other in the vertical direction.
